(19) United States
(12) Patent Application Publication
(10) Pub. No.: US 2006/0168322 A1
(43) Pub. Date: Jul. 27, 2006

(54) Network management apparatus and method for the configuration of network devices

(75) Inventors: Andrew Hunter Gray, Livingston (GB); Simon Peter Valentine, Hemel Hempstead (GB); Daniel Simon Ginger, Hemel Hempstead (GB); Jonathan Owen Mort, Leamington Spa (GB)

Correspondence Address: JACKSON & CO., LLP, 6114 LA SALLE AVENUE, SUITE 507, OAKLAND, CA, 94611-2802, US

(73) Assignee: 3Com Corporation

(21) Appl. No.: 11/133,040

(22) Filed: May 18, 2005

(30) Foreign Application Priority Data
Nov. 29, 2004 (GB) 04 261 59.0

(51) Int. Cl. G06F 15/173

(52) U.S. Cl. 709/238

(57) ABSTRACT

A method for the configuration of devices on a network is described. The method is preferably implemented using a network management software application and comprises initially retrieving configuration information from a text-based configuration file of a selected network device. The method further comprises a user changing a value of a parameter within the retrieved configuration information to a variable token. The variable may comprise an attribute of the network management application or a variable of a network device such as an SNMP MIB variable. The method further comprises applying the changed configuration information to selected network devices, by replacing the variable token with a corresponding value for each of said selected network devices.

### BACKGROUND OF THE INVENTION

1. Field of the Invention

The present invention relates to an apparatus and method for the management of a network, and more particularly to a network management apparatus and method for the configuration of network devices.

2. Description of the Related Art

The following description is concerned with a data communications network, and in particular a local area network (LAN). It will be appreciated, however, that the invention but has more widespread applicability to other managed communications systems including wide area networks (WANs) and wireless communications systems.

Networks typically comprise a plurality of network devices comprising inter alia computers, peripherals and other electronic devices, which are capable of communicating with each other by sending and receiving data packets in accordance with predefined network protocols. Each network device is connected by a port to the network media, which in the case of a conventional LAN network may be coaxial cable, twisted pair cable or fibre optic cable. A network is generally configured with core devices (also referred to herein as “interconnecting devices”) having a plurality of ports, which can be used to interconnect a plurality of media links on the network. Such devices include hubs, switches and routers which pass data packets received at one port to one or more of its other ports, depending upon the type of device.

Typically, a network needs to be maintained or “managed” after installation to ensure the proper and efficient operation of the network. For this purpose, a network administrator is appointed to perform network management using a designated workstation, the “network management station”. It will be appreciated that for large-scale networks, there may be more than one network management station, each responsible for managing a particular part of the network.

The network management station typically runs a network management software application, which may send network management messages and commands to, and receive messages and network management data from, network devices using predefined network management protocols. One such protocol used for network management is the Simple Network Management Protocol (SNMP).

The following description relates to the management of a network using SNMP. However, the skilled person will appreciate that the present invention is not limited to use with SNMP or other network management protocols. Nevertheless, it is convenient for the purposes of the following description to provide a brief overview of SNMP, which is typical of a network management protocol.

SNMP defines agents, managers and MIBs (where MIB is Management Information Base), as well as various predefined messages and commands for communication of management data. An agent is typically present in SNMP-capable interconnecting devices, which have the ability to monitor data packets passing through their ports and obtaining data relevant for network management, and responding to requests from the manager, for instance by providing network management data. A manager is present within the network management station of a network and communicates with the agents of managed devices on the network using various SNMP commands. A MIB is a managed “object” database, which stores management data obtained by managed devices and is accessible to agents for network management applications.

One of the functions of a network administrator is to configure the network, and for this purpose, the network management application running on the network management station includes a configuration tool. Configuration of the network involves inter alia setting configuration parameters within network devices, and in particular interconnecting network devices such as hubs, switches and routers. For instance, configuration may set parameters that turn on or off particular ports of an interconnecting device, or that assign ports to particular users or user groups. Configuration may also set parameters which define how the device behaves, or may set parameters that define the device itself such as its name and location.

The skilled person will appreciate that some configuration parameters are automatically detected or determined by interconnecting devices (for example, the physical connection of a cable to a port will be automatically detected) but many configuration parameters are set within SNMP-capable interconnecting network devices using a network management application, conventionally using SNMP or other network management commands.

In many network management applications, the network administrator may manually set configuration parameters using the GUI of the network management application running on the network management station. For example, the network administrator may wish to name a device. Thus, the network management application may provide for the user to input a name of an SNMP-capable device, and for this name to be sent to the SNMP agent of the relevant device as part of its configuration information.

Each interconnecting SNMP-capable device thus maintains its own current configuration information. In the case of most such devices, this configuration information can be retrieved from the device by a network management application for back-up purposes. Thus, if a device at a particular location needs to be replaced, its configuration information can be retrieved from the device prior to its replacement. After installation of a replacement device, the retrieved configuration information can be sent to the replacement device so that the configuration of the device at the particular location, and thus the overall network, is not changed.

Increasingly, vendors of such devices provide a facility whereby the device is capable of providing a back-up file, containing all of the configuration information thereof, in a text-based, and therefore user-readable format. As is well known in the art, the back-up file may be transferred by the device using Trivial File Transfer Protocol (TFTP) (or equivalent protocols) to a device acting as a TFTP server, and such file transfer may be initiated using a web interface into the device, using SNMP, or using a Command Line Interface (CLI) of the device itself.

When changing the configuration of devices on a network, a network administrator frequently may wish to make the same change to the configuration information of a plurality of devices on the network. For example, if the network address of the network management station is changed, the network administrator will need to set parameters within some or all SNMP-capable devices on the network so that they send network management messages, such as SNMP Trap messages, to the new address of the network management station.

The configuration of multiple network devices at one time, often termed “bulk configuration”, is conventionally performed using SNMP commands and requires the network management application to contain instruction code, that performs complex functions, for each parameter that may be configured in bulk. Thus, conventional network management applications typically provide for only a few parameters to be configured in bulk. In addition, the task of bulk configuration is complex, time consuming and can only be performed by a skilled and experienced network administrator.

The present invention therefore aims to provide a simpler and less time consuming technique for performing bulk configuration.

### SUMMARY OF THE INVENTION

According to a first aspect, the present invention provides a method for the configuration of one or more devices on a network, the method comprising: retrieving configuration information from a text-based configuration file of a network device; changing a value of a parameter within the retrieved configuration information to a variable token, replacing the variable token within the changed configuration information with a corresponding value for each of said one or more network devices, and thereafter applying the changed configuration information to said one or more network devices.

The method is preferably implemented using a software application whereby a user can change the text-based configuration information to specify a variable token in a predefined text-based format. In this way, the user can initiate the bulk configuration of a selected plurality of network devices in a single step.

In one embodiment, the variable token specifies a variable that is recognised by said software application. For example, the variable may be an attribute of a network management application or an SNMP MIB variable. In this embodiment, the method further comprises the step of: using said changed configuration information, generating, for each of said one or more network devices, a partial or full individual configuration file in which said variable token is replaced by a corresponding value for the respective device. Thus, if a network management attribute is specified in the variable token, the corresponding value for each device may be retrieved by said network management software application e.g. from memory or an SNMP-capable network device.

In another embodiment, the variable token specifies a variable the value of which, for a given device, is accessible by the device. For example, the variable may be an SNMP MIB variable, the value of which is accessible from the MIB by the SNMP agent of the device. In this embodiment, the method further comprises the step of: using said changed configuration information as part of a partial or full individual configuration file for each of said one or more devices. The partial or full configuration files may be sent to said one or more devices with a corresponding restore/configure command, and each device replaces the variable token with the corresponding SNMP MIB value of the device prior to performing the restore/reconfigure operation.

According to another aspect, the present invention provides a computer readable medium having a computer program for the configuration of one or more devices on a network, the program comprising: program means for retrieving configuration information from a text-based configuration file of a network device; program means for receiving a user entered change of a value of a parameter within the retrieved configuration information to a variable token, program means for replacing the variable token within the changed configuration information with a corresponding value for each of said one or more network devices, and program means for applying the changed configuration information to said one or more network devices.

In accordance with a further aspect, the present invention provides a network management apparatus adapted to carry out a method of configuration of a plurality of devices in accordance with the first aspect of the present invention.

Other preferred features and advantages of the present invention will be apparent from the following description and accompanying claims.

### BRIEF DESCRIPTION OF THE DRAWINGS

Embodiments of the present invention will now be described by way of example with reference to the accompanying drawings, in which:

FIG. 1 is a block diagram of a typical network including a network management system, which may be used to implement the present invention, and

FIG. 2 is flow diagram of the method steps performed using a network management software application in accordance with an embodiment of the present invention.

### DETAILED DESCRIPTION

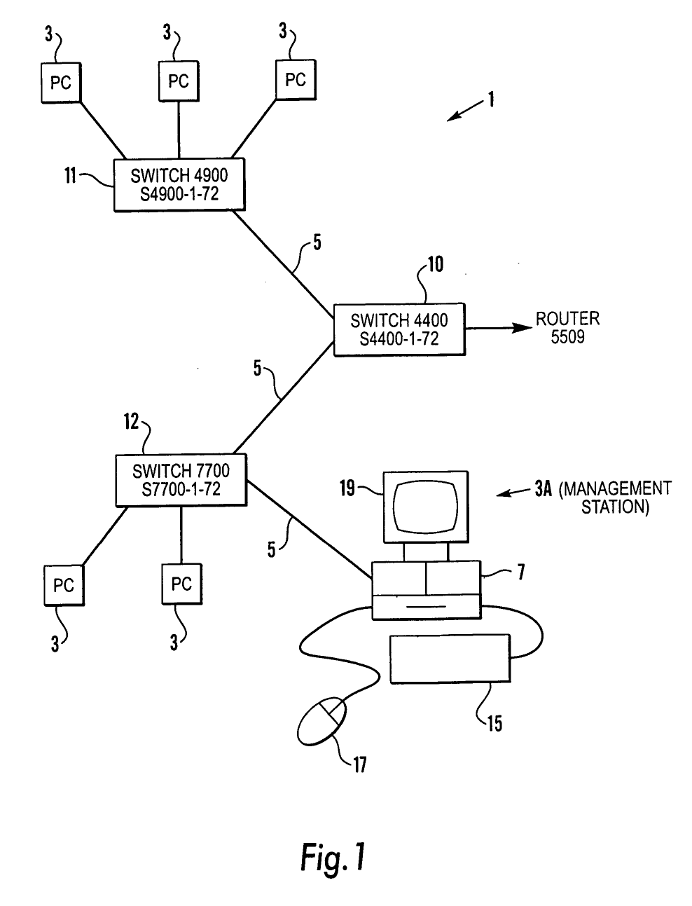

FIG. 1 shows a typical network 1 incorporating a network management system. The network 1 includes a network management station 3A, which incorporates the necessary hardware and software for network management. In particular, the network management station 3A includes a processor, a memory and a disk drive within housing 7 as well as user interfaces such as a keyboard 15 and mouse 17, and a visual display unit 19. Network management application software in accordance with the present invention is loaded into the memory of management station 3A for processing data as described in detail below. The network management station 3A is connected by network media links 5 to a plurality of network devices including core or interconnecting devices such as network switches 10, 11 and 12, and hubs (not shown) and a router (not shown), and end stations including personal computers (PCs) 3 and workstations. The network 1 may also include other devices, for example peripheral devices such as printers, IP telephones, wireless network access points etc.

The network management station 3A includes a network management software application which is capable of communicating with the network switches 10, 11 and 12 by means of inter alia a network management protocol, in the present embodiment the SNMP protocol, in order to obtain network management data. In addition, the network management application includes a configuration tool to allow the user of the network management station 3A (i.e. the network administrator) to configure devices on the network.

The configuration tool in accordance with a preferred embodiment of the present invention allows a user to concurrently apply the same or an equivalent configuration to a plurality of devices, i.e. it provides for “bulk configuration”.

The network management application includes a Graphical User Interface (GUI) on the display screen 19 of the network management station 3A, which provides a user selectable facility for the bulk configuration of multiple devices on the network 1.

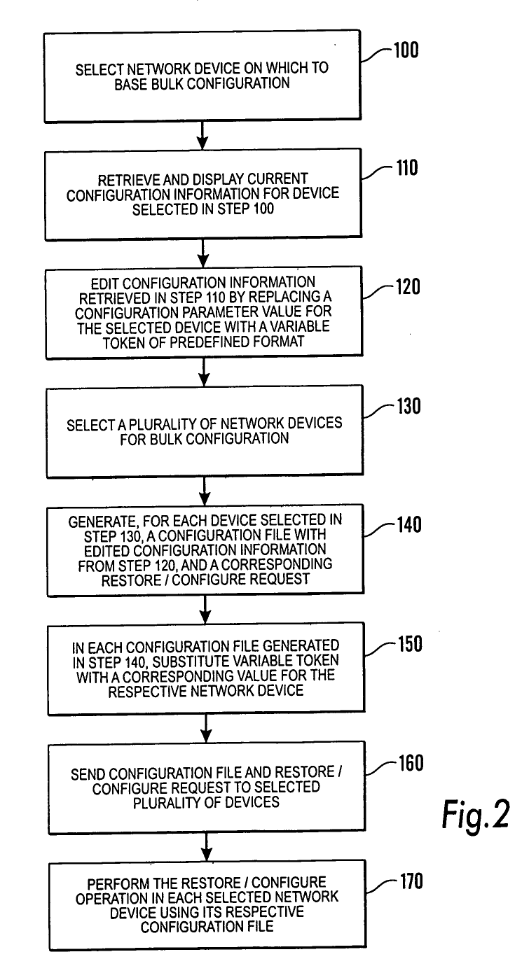

When a user selects this bulk configuration facility of the configuration tool, the network management application performs a method according to the present invention as shown generally in FIG. 2.

At step 100, the user selects from the GUI, using a selecting device such as a keyboard 15 or mouse 17, a device on the network whose current configuration will be used as a basis for the configuration or reconfiguration of a plurality of devices (i.e. bulk configuration). For example, if the user wishes to configure all SNMP-capable devices on the network so that they send any SNMP Trap messages to a new network address, then at step 100 the user may select a typical SNMP-capable device on network 1 such as switch 10 (S4400-1-72).

In response to the selection of a network device by a user, at step 110 the method retrieves the current back-up configuration file for the selected network device (i.e. switch 10) in a text-based format and stores it in memory. The back-up configuration file, hereinafter called “configuration file” for simplicity, is typically retrieved directly from the device using conventional techniques as described above. Thus, step 110 may use SNMP to instruct the selected device to transfer its configuration file to the network management station 3A by TFTP.

The configuration information (or selected parts thereof) from the retrieved configuration file is also displayed in the GUI on the display screen 19 of the network management station 3A at step 110.

At step 120, using the GUI and keyboard 15, the user edits the text of at least one parameter within the displayed configuration information of the retrieved configuration file by replacing a value for a configuration parameter specified therein (which value is specific to the network device selected in step 100) with a variable token in a predefined format. The variable specified in the variable token is recognisable by the network management application and/or the network devices that are being configured, as discussed in further detail below.

At step 130, the user then selects a plurality of network devices for bulk configuration. In particular, using the GUI and a selecting device, the user selects, from a list of devices on network 1, the devices to be configured using the edited version of the configuration information. For example, the user may select switches 10, 11 and 12. Once the user is satisfied with the selection, he or she initiates the bulk configuration of the selected devices based on the edited configuration information, for example using a single or double click of the mouse 17 or pressing the enter key of keyboard 15.

At step 140, the method then generates, for the selected plurality of devices, a corresponding plurality of individual configuration files (which may be partial or full configuration files) together with a restore/configure command.

At step 150, the method replaces the variable token within each configuration file generated in step 140, with a corresponding value for the variable of the network device to which the configuration file is to be applied. It will be appreciated that this step of replacing the variable token in the edited configuration information with a corresponding value may be performed before, concurrently with, or after generation of the individual configuration files in accordance with step 140.

As will be apparent from the Examples below, in most cases, the device-specific values for the variable specified in the variable token is determined by the network management application, and these values are substituted in the individual configuration files by the network management application prior to sending them to the network devices. However, in other cases, the variable token may specify variables which may be determined by the network device itself so that the generated individual configuration files may include the variable token instead of a value. In this case, the substitution of the variable with a corresponding value (step 150) is performed separately in each device after the network management application sends the individual configuration files to the network devices.

At step 160, the method sends the plurality of individual, partial or full configuration files to the corresponding plurality of network devices with the restore/configure command generated in step 140.

At step 170, each of the plurality of network devices receives its respective individual configuration file and restore/configure command, and performs the restore/configure operation to apply the new configuration, thereby completing the bulk configuration process. It will be appreciated that if the individual configuration file received in step 170 contains a variable token, the device performs substitution of a value corresponding to the variable prior to performing the restore/configure operation.

Whilst in the method of FIG. 2 a variable token is specified by the user for a single configuration parameter in the configuration information, the skilled person will appreciate that, in practice, a plurality of variable tokens may be used for a corresponding plurality of configuration parameters. In this way, configuration can be performed on multiple devices to change a plurality of configuration parameters at one time.

The following Examples provide details of possible variable tokens, and preferred predefined formats thereof, which may be specified by the user in step 120 of the method of FIG. 2. In these Examples, the variable token begins with the symbol $ to signify (i.e. define) a variable token followed by a bracketed variable term, the values for which may be directly derivable by the network management application, for instance from memory associated with the network management application or by retrieving the value from an SNMP agent of a network device being configured. Other formats for the variable token will be apparent to the skilled person.

### EXAMPLE 1

The value for the variable is defined by the user using the GUI of the network management application.

The following illustrates a partial, text-based configuration file in which the four parameters of the configuration of an originally selected device (e.g. switch 4400-1-72) are edited by the user to specify token variables (which begin with the symbol $) in place of specific values:
System management name “$(name)”
System management location “$(location)”
System management contact “$(contact)”
Set trap destination 1=“$(ip address)”

Where:

“name”, “location” and “contact” are attributes (variables) for network devices already implemented in the network management application and therefore derivable from memory associated with the network management station or an external database, and

37 ip address” is entered by the user in the GUI of the network management application as the ip address of a new network management station (e.g. ip address=XXX.YYY.Z.0).

Thus, when generating the plurality of configuration files (which may be partial configuration files if partial reconfiguration is permitted in conjunction with the network devices being configured) according to step 140 of the method of FIG. 2, the network management application parses the above partial configuration file and determines the respective values of the variables for each of the plurality of devices selected at step 130. For example, the configuration file generated for the original device called “Switch4400-1-72” is thus:
System management name “Switch4400-1-72”
System management location “Rack 7, Machine Room 6”
System management contact “Joe User”
Set trap destination 1=“XXX.YYY.Z.0”

These token names and values for the device selected at step 100 (or any other device) may be displayed to the user in a window in a separate step between the editing stage at step 120 and the applying stage at step 130 in order for the network administrator to check that the variables have been correctly recognised and derived by the network management application.

In accordance with this Example by defining the values for the variables within the user interface, the user (network administrator) is able to constrain the features that ordinary users or operators can access.

### EXAMPLE 2

The variable is defined by an SNMP MIB variable the value for which is derivable by the network management application from an SNMP-capable network device or the network device itself.

The following illustrates the same partial, text-based configuration file as that of Example 1 in which the four parameters are edited by the user to specify token variables as SNMP MIB variables in place of specific values. The MIB variables may be retrieved by the SNMP manager of the network management application from the SNMP agent of the device being configures (or indeed the SNMP agents of other user-specified devices on the network), this Example enables the user to ensure that the new configuration file preserves existing values on each of the plurality of devices:
System management name “$(mib-ii.sysName.0)”
System management location “$(mib-ii.ifDescr.101)”
System management contact “$(identityMIB.username.5)”
Set trap destination 1=“$(probeConfig.trapDestination.101)”

Thus, in this Example, the user edits the partial configuration file in step 120 of FIG. 2 by specifying variable token strings in place of parameter values.

The values, corresponding to the identified MIB variables, are derived from the agents of the relevant SNMP-capable devices, and are substituted in the individual configuration files (step 150) by the network management application prior to sending the configuration files or by each device upon receipt of its configuration file. Thus the identified MIB variables in the edited configuration file (i.e. “mib-ii.sysName.0”; “mib-ii.ifDescr.101”, and “identityMIB.username.5”) are replaced with the current MIB values for the device (i.e. “Switch4400-1-72”; “Rack 7, Machine Room 6”, and “Joe User”) in the individual configuration file for a device before the file is applied by the device when performing the restore/configure operation, thereby preserving the parameters for name, location and contact.

Similarly, the MIB value identified by the MIB variable “probeConfig.trapDestination.101”, which specifies an ip address such as “XXX.YYY.Z.0”, is substituted in the individual configuration file for a device before the file is applied by the device when performing the restore/configure operation.

### EXAMPLE 3

The variable specifies search criteria to determine a MIB index which may be used as the index into another MIB table to obtain the value required.

For example, the user may input the variable for the parameter “system management name” as the search criteria:

“$(identityMIB.userName.$(mib-ii.ifDescr=“Interface 1”)”

whereby the index into “identityMIB.userName” is first identified by performing a search of the MIB-II “if description” Table to identify the index for the value “Interface 1”.

Thus, if the index value is determined to be the value “5” then the parameter is resolved to:

“$(identityMIB.username.5)”

This Example is useful for instances in which the index value of the parameter value is unknown or may change from device to device.

The method of configuration of network devices has numerous advantages, which will be apparent to the skilled person. For instance, by basing the configuration on a text-based configuration file of an existing network device, it is not necessary to provide instruction code in the network management application to support each and every network device or software release. Thus, even devices of third party vendors can be supported by a network management software application having a configuration tool embodying the present invention. In addition, since the variable tokens are user-defined, there is no constraint on the particular configuration parameters that may be reconfigured.

It will further be appreciated that whilst the present invention is particularly useful for the configuration of a plurality of devices at one time, it may be used to configure parameters of a single device where the network management application does not provide for or support the configuration of one or more such parameters.

As the skilled person will appreciate many variations and modifications may be made to the described embodiments. It is intended to include all such variations, modifications and equivalents that fall within the spirit and scope of the present invention.

1. A method for the configuration of one or more devices on a network, the method comprising:
retrieving configuration information from a text-based configuration file of a network device;
changing a value of a parameter within the retrieved configuration information to a variable token;
replacing the variable token with a corresponding value for each of said one or more network devices, and thereafter:
applying the changed configuration information to said one or more network devices.

2. A method as claimed in claim 1, wherein prior to the step of applying, the method further comprises:
selecting said one or more devices for configuration.

3. A method as claimed in claim 1, wherein after said step of changing, the method further comprises:
initiating the generation of a corresponding one or more individual, partial or full configuration files, using said changed configuration information, for said one or more devices.

4. A method as claimed in claim 3, further comprising generating, for each of said one or more devices, a restore/configure command for sending to the respective device with said respective individual configuration file.

5. A method as claimed in claim 4, further comprising sending said restore/configure command with said individual configuration file to said one or more devices.

6. A method as claimed in claim 3, further comprising:
in response to said initiating step, and using said changed configuration information, generating, for each of said one or more network devices, an individual configuration file.

7. A method as claimed in claim 6, in which said replacing step comprises replacing said variable token with a corresponding value for the respective device in each individual configuration file.

8. A method as claimed in claim 7, wherein said variable token specifies an attribute of network management software application, and wherein said replacing step includes retrieving said corresponding value for said attribute from memory associated with said network management software application.

9. A method as claimed in claim 7, wherein said variable token specifies a MIB variable associated with a specified network device, and wherein said replacing step includes retrieving said corresponding MIB value from the specified network device.

10. A method as claimed in claim 3, wherein if said variable token specifies a variable the value of which, for a given device, is accessible by the device, the method further comprises the step of:
using said changed configuration information as part of said individual configuration file for each of said plurality of devices.

11. A method as claimed in claim 10, further comprising sending said one or more individual configuration files to said plurality of network devices with a restore/ configure command to perform a restore/configure operation.

12. A method as claimed in claim 11, wherein when one of said one or more devices receives a corresponding individual configuration file, the device replaces the variable token in the received individual configuration file with a corresponding value of the variable for said device prior to performing said restore/configure operation.

13. A method as claimed in claim 10, wherein the variable token specifies an SNMP MIB variable which is directly accessible to an SNMP agent of said one or more devices.

14. A network management apparatus adapted to carry out a method of configuration of a plurality of devices as claimed in claim 1.

15. On a computer readable medium, a computer program for the configuration of one or more devices on a network, the program comprising:
program means for retrieving configuration/back-up information from a text-based configuration file of a network device;
program means for receiving a user entered change of a value of a parameter within the retrieved configuration information to a variable token;
program means for replacing the variable token within the changed configuration information with a corresponding value for each of said one or more network devices, and
program means for applying the changed configuration information to a one or more network devices.
